(19) United States
(12) Patent Application Publication
(10) Pub. No.: US 2011/0226401 A1
(43) Pub. Date: Sep. 22, 2011

(54) TIRE THAT INCLUDES AN ELECTRONIC COMPONENT

(75) Inventors: Claudio BATTOCCHIO, Riom (FR); Arnaud BOURSIN, Chappes (FR)

(73) Assignees: SOCIETE DE TECHNOLOGIE MICHELIN, Clermont-Ferrand (FR); MICHELIN RECHERCHE ET TECHNIQUE S.A., Granges-Paccot (CH)

(21) Appl. No.: 13/032,031

(22) Filed: Feb. 22, 2011

Related U.S. Application Data
(60) Provisional application No. 61/307,613, filed on Feb. 24, 2010.

(30) Foreign Application Priority Data
Feb. 23, 2010 (FR) 1051284

(51) Int. Cl. B60C 19/00; B60C 9/02; B60C 9/16

(52) U.S. Cl. 152/548

(57) ABSTRACT

An aeroplane tire that operates at an inflation pressure in excess of 12 bar includes a crown, two sidewalls, two beads, a carcass ply reinforcement anchored in the two beads and including at least one ply of textile reinforcements, a crown reinforcement, and an electronic component. The crown reinforcement includes, radially from inside outward, a working block that includes plies of textile reinforcement, and a protective block that includes reinforcements directed substantially circumferentially. The electronic component has elongate overall shape and includes a passive radio frequency identification device transponder equipped with two antennas forming a dipole. The electronic component is positioned in the tire under the crown, radially on an inside portion in relation to the carcass ply reinforcement, and directed in a substantially axial direction.

### CROSS REFERENCE TO RELATED APPLICATION

This application claims the benefit of U.S. Provisional Application No. 61/307,613 filed on Feb. 24, 2010, the entire disclosure of which is incorporated by reference herein.

### FIELD OF THE INVENTION

The present invention relates to a tire comprising an electronic component.

It applies in particular, although not exclusively, to a tire intended to support heavy loads and inflated to a very high pressure in excess of 12 bar, such as an aeroplane tire, for example.

### RELATED ART

A tire that meets the above criteria usually comprises a carcass ply reinforcement equipped with textile threads, unlike a tire for a heavy goods vehicle, which generally comprises carcass ply threads made of a metallic material.

The axial, radial, and circumferential directions of a tire will be defined herein in relation to an axis of revolution of this tire.

EP 0 389 406 discloses a tire comprising an electronic component. In that document, the electronic component comprises a passive radio frequency identification device transponder equipped with two antennas forming a dipole. This type of transponder is generally known by the English-language acronym RFID. Such a component can store data, for example, relating to the manufacture of the tire.

The tire described in EP 0 389 406, notably illustrated in FIG. 2 of that document, comprises an annular bead wire, of revolution about an axis that coincides substantially with the axis of revolution of the tire and a carcass ply reinforcement of generally toroidal shape, coaxial with the bead wire, comprising a part folded around the bead wire.

The transponder is positioned in the tire's mass so that within the tire it creates an interface with materials, namely the interface defined by the junction between at least a first mass of rubber and a second mass formed by the transponder.

In EP 0 389 406, part of the transponder, particularly one of the antennas, extends in the volume contained between the folded-back part of the carcass ply reinforcement and a part of this carcass reinforcement that axially faces the folded-back part.

### SUMMARY OF THE INVENTION

Now, it has been found that, in the case of an aeroplane tire, the positioning of the transponder as proposed in EP 0 389 406 is not optimized because of the particularly high loadings to which this tire is subjected in service, which may cause the transponder, and notably its antennas, to break.

According to an aspect of the invention, an electronic component, such as a transponder, is positioned within a tire's mass so as to optimize the endurance of the transponder and the transmission of the data stored in the transponder. The positioning of the electronic component in the tire is done without altering the key steps of the manufacture of the tire or the architecture thereof.

To this end, an embodiment of the invention is an aeroplane tire having the ability to operate at an inflation pressure in excess of 12 bar, comprising a crown, two sidewalls and two beads, a carcass ply reinforcement anchored in the two beads and including at least one ply of textile reinforcements, a crown reinforcement with, radially from inside outward, a working block comprising at least one ply of textile reinforcement and a protective block comprising reinforcements directed substantially circumferentially, and an electronic component of elongate overall shape, comprising a passive radio frequency identification device transponder equipped with two antennas forming a dipole wherein the reinforcements of the protective block are metal reinforcements laid in a wavy configuration and wherein the electronic component is positioned in the tire's structure under the crown, radially on an inside portion in relation to the carcass ply reinforcement, and directed in a substantially axial direction.

By being positioned axially on an inside portion in relation to the carcass ply reinforcement, the component is closer to the surface of the tire in contact with internal air than is the carcass ply reinforcement.

Directing the electronic component in a substantially axial direction has the advantage of allowing this electronic component to withstand, without damaging the shaping of the tire in its green state during the course of its manufacture, that is to say, the operation in which, having layered the first products, notably an inner liner, the component, the carcass ply reinforcement, and the bead wires on a tire-building drum, in giving this cylindrical green tire a toric shape. Moreover, it has been found that, with the component directed axially, the metal reinforcements of the protective block do not limit the effectiveness of the radio frequency transmission of the data by the component.

Advantageously, with the tire comprising a mass of rubber forming the inner liner, delimited by an internal surface in contact with air inside the tire, and an outer surface in contact with a mass of adjacent rubber, the electronic component is positioned at an interface between the inner liner and the mass of adjacent rubber.

This position of the electronic component according to the embodiment allows the electronic component to be fitted easily at the time of assembly of the materials of the tire in the raw state. What is more, that can be done irrespective of the variations in architecture on the outside of the carcass ply reinforcement.

The electronic component is also particularly well protected against external stresses such as impacts of the tire with an obstacle or pot hole on the runway.

By being positioned inside the tire's structure, the component is also protected from any type of contaminant that may be situated inside an internal cavity of the tire (e.g., water, oil, sealants, etc.).

Finally, this position gives the component substantially better endurance in comparison with any position on the outside of the carcass ply reinforcement.

Advantageously, the electronic component is positioned under the crown of the tire in the middle along a width of the crown.

With this arrangement, transmission of data by the electronic component is entirely satisfactory. Positioning it in the middle along the width of the crown has the advantage that the component is “read” from the same distance whether it is on the left side or on the right side of the tire.

According to another optional feature of the tire according to an embodiment of the invention, the electronic component is enveloped in a mass of coating rubber.

Advantageously, a relative dielectric constant of the mass of coating rubber is lower than a relative dielectric constant of the inner liner and a relative dielectric constant of the mass of adjacent rubber.

Thanks to the coating rubber, the transmission of stored data by the electronic component is improved. That is, in general, the higher the dielectric constant of the mass of coating rubber enveloping the electronic component, the greater the attenuation of the electrical signal received and transmitted by the electronic component. As the dielectric constants of the inner liner and the mass of adjacent rubber are generally higher than 10 in the UHF range, the transmission of data is greatly enhanced if the relative dielectric constant of the coating rubber is lower than the relative dielectric constants of the inner liner and the adjacent rubber in the frequency band used. For example, the dielectric constant of the coating rubber is below 4 or even below 3 in the UHF frequency band.

In an example embodiment of the invention, the mass of coating rubber has a limited length in an axial direction, which length exceeds a length of the electronic component by just a few millimetres at each of its ends. For example, a quantity of a few millimetres is of the order of three to five millimetres.

The mass of adjacent rubber may include the carcass ply reinforcement. This mass of adjacent rubber may also include a mass of additional rubber positioned between the inner liner and the carcass ply reinforcement of the tire. The presence of such a mass of additional rubber is common place in aeroplane tire designs.

The inner liner may also, according to an example embodiment, include an assembly of at least two masses of rubber.

### BRIEF DESCRIPTION OF THE DRAWINGS

The invention will be better understood upon reading the description, which will follow, given solely by way of nonlimiting example(s) and made with reference to the drawings, of which:

FIG. 1 is a view in radial cross section of part of a tire according to an embodiment of the invention;

FIG. 2 is a detail of the tire of FIG. 1;

FIG. 3 is a detail of a tire according to another embodiment of the invention; and

FIG. 4 is a highly schematic perspective view of the part of the tire from FIG. 1, shown with a cutaway portion.

### DETAILED DESCRIPTION OF THE INVENTION

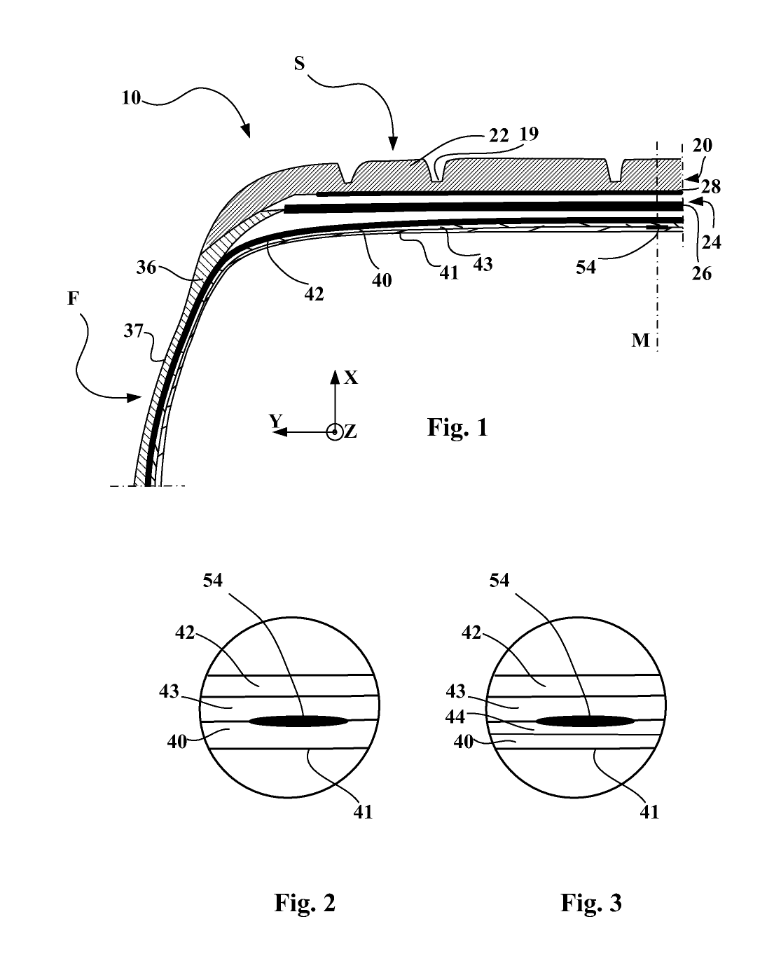

FIG. 1 shows mutually orthogonal axes X, Y, Z, which correspond to the customary radial (X), axial (Y) and circumferential (Z) orientations of a tire.

As used herein “substantially circumferential direction” refers to a mean direction that deviates from the circumferential direction Z by no more than five degrees.

FIGS. 1 to 4 depict a tire according to embodiments of the invention, denoted by the overall reference numeral 10. In these figures, the tire 10 is intended to be mounted on an aeroplane wheel.

In the conventional way, the tire 10 comprises a crown S extended by two sidewalls F and two beads B. Just one sidewall F and the crown S have been depicted in FIG. 1.

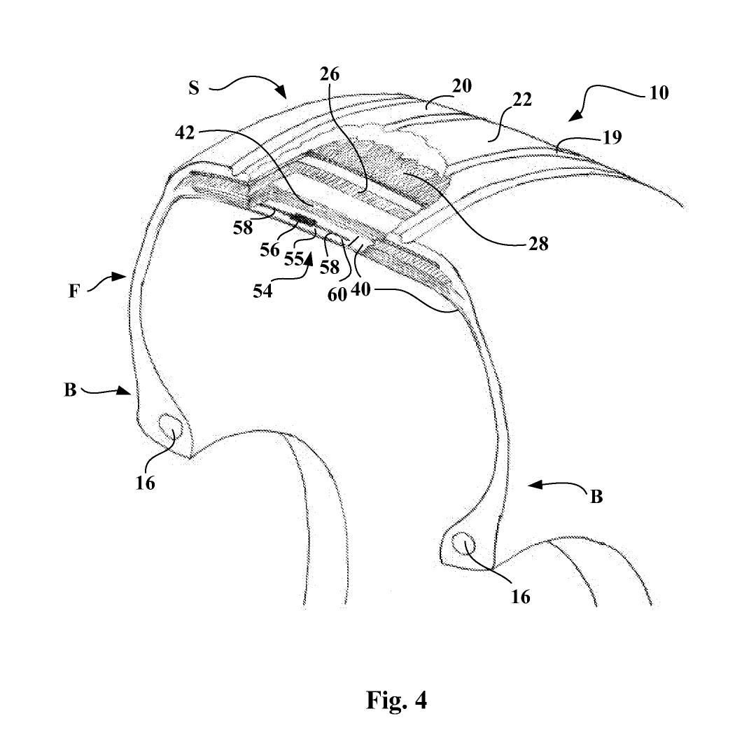

Bead wires 16 are each embedded in one bead B. For example, two bead wires 16 are arranged symmetrically with respect to a radial mid plane M of the tire 10 (see FIG. 4).

Each bead wire 16 is of revolution about a reference axis. This reference axis, substantially parallel to the Y direction, is substantially coincident with an axis of revolution of the tire 10.

The crown S comprises a tread strip 20, equipped with tread patterns 22, and a crown reinforcement 24. This reinforcement 24 comprises a working block 26 and a protective block 28. The working block 26 comprises several plies of textile reinforcements. The protective block 28 preferably comprises metal reinforcements laid in a wavy configuration in the plane of the crown S in order to obtain the greatest possible effectiveness. Each reinforcement maintains a substantially circumferential mean direction.

A mass of rubber 36 extends radially from the crown S as far as the bead wire 16 of the bead B, delimiting an exterior surface 37 of the sidewall F and of the bead B.

The tire 10 also comprises a mass of airtight inner rubber 40, and a carcass ply reinforcement 42. The mass of inner rubber or inner liner 40 is delimited by an internal surface 41 in contact with air inside the tire 10, and an outer surface in contact with a mass of adjacent rubber. Depending on the architecture of the tire, the adjacent rubber may be the carcass ply reinforcement 42 or one or more additional rubbers positioned between the inner liner 40 and the carcass ply reinforcement 42. In the example of FIG. 1, between the carcass ply reinforcement 42 and the airtight inner liner 40 there is a mass of additional rubber 43. This mass of additional rubber 43 extends from one bead to the other between the carcass ply reinforcement 42 and the airtight inner liner 40. The carcass ply reinforcement 42 in the example depicted comprises one or more plies of textile reinforcements directed substantially radially.

The crown S of the tire 10 also comprises an electronic component 54 optionally coated in a mass of rubber 60. In an embodiment, the electronic component 54 is of elongate overall shape in a substantially axial direction Y (parallel to the axis of rotation). In this embodiment, the component 54 comprises a passive radio frequency identification device (RFID) transponder 56 equipped with two antennas 58 forming a dipole.

The component 54 is positioned between the inner liner 40 and the carcass ply reinforcement 42. FIG. 2, which shows a detail of FIG. 1, illustrates the position of the component 54 in the crown S. Between the inner liner 40 and the carcass ply reinforcement 42 there is the additional rubber 43. The component 54 is positioned at the interface between the additional rubber 43 and the inner liner 40. If there is no such additional rubber 43 then the component 54 may be positioned at the interface between the inner liner 40 and the carcass ply reinforcement 42. It will be recalled that the carcass ply reinforcement 42 includes one or more plies each comprising textile reinforcements of substantially radial direction embedded between two layers of calendering or calendered rubber. There is therefore no direct contact between the component 54 and the reinforcements of the carcass ply reinforcement 42.

The component 54 may also be positioned at the interface between the additional rubber 43 and the inner liner 40, or at the interface between the carcass ply reinforcement 42 and the additional rubber 43. In an embodiment, the component 54 is positioned in the middle of the crown S, near the mid plane M.

FIG. 3 shows, in a similar way to FIG. 2, a detail of a tire according to another embodiment of the invention, in which the inner liner 40 includes an assembly of two masses of rubber, a first mass of rubber corresponding to the airtight liner 40 and a second mass of additional rubber 44. The electronic component 54 is therefore positioned at the interface between the first mass of additional rubber 43 and the second mass of additional rubber 44.

FIG. 4 is a highly schematic perspective view showing a partial cutaway of the outer face of the tire 10.

As shown in FIG. 4, the exterior surface of the tire 10 includes the tread strip 20 tire with the tread patterns 22 comprising four circumferential grooves 19. Under the tread strip 20 is the crown reinforcement protective block 28. This protective block 28 comprises a ply of metal reinforcements laid in a wavy configuration while maintaining a circumferential mean direction. Under the protective block 28 may be seen the working block 26 made up of small strips of textile reinforcements laid at an angle of the order of ten degrees or so relative to the circumferential direction, alternating from one layer of reinforcements to the next, optionally supplemented by reinforcements directed substantially circumferentially. Between the blocks 28 and 26 of the crown reinforcement 24 on the one hand and between the crown reinforcement 24 and the carcass ply reinforcement 42 there are masses of cushioning rubber.

Under the working reinforcement block 26 there are multiple reinforcing plies directed axially under the crown S (and radially in the sidewalls F), constituting the carcass ply reinforcement 42. Under this carcass ply reinforcement 42 is the component 54, optionally surrounded by a coating rubber 60, positioned on the inner liner 40. This schematic figure does not shown any mass of additional rubber 43. The internal surface of the tire 10 in contact with the air inside the tire 10 is the internal surface of the mass of rubber referred to as the inner liner 40. The electronic component 54 includes a passive radio frequency identification device (RFID) transponder 56 equipped with the two antennas 58 forming a dipole. The assembly is directed in the axial direction parallel to hoops of the reinforcements of the carcass ply reinforcement 42. The electronic component 54 is enveloped in a mass of coating rubber 60 comprising two thin layers 55 of a mass of rubber. These two layers 55 extend axially beyond the antennas 58 by a distance ranging between 3 and 5 mm. The two layers 55 are part of the mass of coating rubber 60 of the component 54. The axial orientation of the antennas 58 of the component 54 means that signal transmission remains excellent even in the presence of the metal reinforcements of the crown reinforcement protective block 28. This is because these metal reinforcements are directed circumferentially. This axial orientation also gives the component good endurance in the tire 10 during its manufacture and service.

The dielectric constant of the coating rubber 60 is lower than the dielectric constants of the inner liner 40 and the additional rubber 43, and of the calendered rubbers of the carcass ply reinforcement 42.

The insertion of the electronic component 54 into the tire's structure at the time of its building is as follows. Having placed the inner liner 40 on a building drum, an assembly comprising the component 54 and the mass of coating rubber 60 is applied at an appropriate location, the additional rubber 43 is then applied followed by the carcass ply reinforcement 42. Then, the application of all the rubbers and products needed to form the green form of the tire 10 is completed in the usual way. Once this green tire has been vulcanized, a tire cover or a tire ready for use is obtained.

The interface chosen at which to locate the electronic component 54 may vary according to the manufacturing techniques employed. When a semi-finished assembly that includes the inner liner 40 and of an adjacent rubber is produced, the interface between this inner liner 40 and the adjacent rubber is not available for the placement of the component 54 during manufacture of the tire 10. The component 54 would therefore be positioned at the interface between the additional rubber 43 and the carcass ply reinforcement 42 of the tire 10 in the example of FIG. 2. In the case of FIG. 3, the component 54 is placed at the interface between the additional rubber 43 and a second additional rubber 44 adjacent to the inner liner 40.

The invention is not restricted to the exemplary embodiments described and depicted and various modifications can be made thereto without departing from its scope as defined by the attached claims.

1. An aeroplane tire that operates at an inflation pressure in excess of 12 bar, comprising:
a crown;
two sidewalls;
two beads;
a carcass reinforcement anchored in the two beads, the carcass reinforcement including at least:
one ply of textile reinforcements,
a crown reinforcement with, radially from inside outward, a working block that includes plies of textile reinforcement, and
a protective block that includes reinforcements directed substantially circumferentially; and
an electronic component of elongate overall shape, the electronic component including a passive radio frequency identification device transponder equipped with two antennas forming a dipole,
wherein the reinforcements of the protective block are metal reinforcements laid in a wavy configuration,
wherein the electronic component is positioned under the crown, radially on an inside portion in relation to the carcass ply reinforcement, and is directed in a substantially axial direction.

2. The aeroplane tire according to claim 1, further comprising:
a mass of rubber forming an inner liner, the mass of rubber being delimited by an internal surface in contact with air inside the tire and an outer surface in contact with a mass of adjacent rubber, such that the electronic component is positioned at an interface between the inner liner and the mass of adjacent rubber.

3. The aeroplane tire according to claim 2, wherein the carcass ply reinforcement includes the mass of adjacent rubber.

4. The aeroplane tire according to claim 2, wherein the mass of adjacent rubber includes a mass of additional rubber positioned between the inner liner and the carcass ply reinforcement.

5. The aeroplane tire according to claim 3, wherein the inner liner includes an assembly of at least two masses of rubber.

6. The aeroplane tire according to claim 4, wherein the inner liner includes an assembly of at least two masses of rubber.

7. The aeroplane tire according to claim 1, wherein the electronic component is positioned in a middle portion along a width of the crown.

8. The aeroplane tire according to claim 2, wherein the electronic component is positioned in a middle portion along a width of the crown.

9. The aeroplane tire according to claim 3, wherein the electronic component is positioned in a middle portion along a width of the crown.

10. The aeroplane tire according to claim 4, wherein the electronic component is positioned in a middle portion along a width of the crown.

11. The aeroplane tire according to claim 1, wherein the electronic component is enveloped by a mass of coating rubber.

12. The aeroplane tire according to claim 2, wherein the electronic component is enveloped by a mass of coating rubber.

13. The aeroplane tire according to claim 3, wherein the electronic component is enveloped by a mass of coating rubber.

14. The aeroplane tire according to claim 4, wherein the electronic component is enveloped by a mass of coating rubber.

15. The aeroplane tire according to claim 11, wherein a dielectric constant of the mass of coating rubber is lower than each of a dielectric constant of the inner liner and a dielectric constant of the mass of adjacent rubber.

16. The aeroplane tire according to claim 12, wherein a dielectric constant of the mass of coating rubber is lower than each of a dielectric constant of the inner liner and a dielectric constant of the mass of adjacent rubber.

17. The aeroplane tire according to claim 13, wherein a dielectric constant of the mass of coating rubber is lower than each of a dielectric constant of the inner liner and a dielectric constant of the mass of adjacent rubber.

18. The aeroplane tire according to claim 14, wherein a dielectric constant of the mass of coating rubber is lower than each of a dielectric constant of the inner liner and a dielectric constant of the mass of adjacent rubber.

19. The aeroplane tire according to claim 11, wherein the mass of coating rubber has a length in an axial direction that exceeds a length of the electronic component at each end of the mass of coating rubber.

20. The aeroplane tire according to claim 12, wherein the mass of coating rubber has a length in an axial direction that exceeds a length of the electronic component at each end of the mass of coating rubber.

21. The aeroplane tire according to claim 13, wherein the mass of coating rubber has a length in an axial direction that exceeds a length of the electronic component at each end of the mass of coating rubber.

22. The aeroplane tire according to claim 14, wherein the mass of coating rubber has a length in an axial direction that exceeds a length of the electronic component at each end of the mass of coating rubber.

23. The aeroplane tire according to claim 15, wherein the mass of coating rubber has a length in an axial direction that exceeds a length of the electronic component at each end of the mass of coating rubber.

24. The aeroplane tire according to claim 16, wherein the mass of coating rubber has a length in an axial direction that exceeds a length of the electronic component at each end of the mass of coating rubber.

25. The aeroplane tire according to claim 17, wherein the mass of coating rubber has a length in an axial direction that exceeds a length of the electronic component at each end of the mass of coating rubber.

26. The aeroplane tire according to claim 18, wherein the mass of coating rubber has a length in an axial direction that exceeds a length of the electronic component at each end of the mass of coating rubber.

27. The aeroplane tire according to claim 19, wherein the length of the mass of coating rubber in the axial direction exceeds the length of the electronic component by 3 to 5 mm.

28. The aeroplane tire according to claim 20, wherein the length of the mass of coating rubber in the axial direction exceeds the length of the electronic component by 3 to 5 mm.

29. The aeroplane tire according to claim 21, wherein the length of the mass of coating rubber in the axial direction exceeds the length of the electronic component by 3 to 5 mm.

30. The aeroplane tire according to claim 22, wherein the length of the mass of coating rubber in the axial direction exceeds the length of the electronic component by 3 to 5 mm.

31. The aeroplane tire according to claim 23, wherein the length of the mass of coating rubber in the axial direction exceeds the length of the electronic component by 3 to 5 mm.

32. The aeroplane tire according to claim 24, wherein the length of the mass of coating rubber in the axial direction exceeds the length of the electronic component by 3 to 5 mm.

33. The aeroplane tire according to claim 25, wherein the length of the mass of coating rubber in the axial direction exceeds the length of the electronic component by 3 to 5 mm.

34. The aeroplane tire according to claim 26, wherein the length of the mass of coating rubber in the axial direction exceeds the length of the electronic component by 3 to 5 mm.
